(19) United States
(12) Patent Application Publication
(10) Pub. No.: US 2011/0176830 A1
(43) Pub. Date: Jul. 21, 2011

(54) IMAGE FORMING APPARATUS AND IMAGE FORMING METHOD

(75) Inventors: Masato Ogasawara, Tokyo (JP); Koji Imamiya, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/977,221

(22) Filed: Dec. 23, 2010

Related U.S. Application Data
(60) Provisional application No. 61/296,971, filed on Jan. 21, 2010.

(51) Int. Cl. G03G 15/00

(52) U.S. Cl. 399/159

(57) ABSTRACT

According to one embodiment, a method of setting, when at least one of image forming units does not perform image formation, an electric field between an image carrier and a transfer device of the image forming unit which does not perform the image formation to have the same direction as that of an electric field between the image carrier and the transfer device which perform the image formation and have a lower strength can be obtained.

### CROSS-REFERENCE TO RELATED APPLICATIONS

This application is based upon and claims the benefit of priority from U.S. Provisional Application No. 61/296,971, filed on Jan. 21, 2010; the entire contents of which are incorporated herein by reference.

### FIELD

Embodiments described herein relate generally to an image forming apparatus.

### BACKGROUND

Conventionally, in a full-color image forming apparatus which has developing devices with a plurality of different colors and overlaps toner images on a surface of a transferred member, a mechanism of recovering toner that is not transferred onto the surface of the transferred member and remains on photoconductors using developing devices is known.

However, in this mechanism, if an image is printed by the developing device on an upstream side, there is a problem in that toner of the color is recovered by the developing device on a downstream side, resulting in a color mixture.

### BRIEF DESCRIPTION OF THE DRAWINGS

FIG. 1 is an exemplary view showing a xxx apparatus according to one embodiment;

FIG. 2 is an exemplary view showing a block diagram illustrating the image forming unit of FIG. 1;

FIG. 3 is an exemplary view showing a flowchart illustrating an image forming method according to one embodiment;

FIG. 4 is a schematic diagram illustrating the photoconductor surface potential and transfer bias during the image formation;

FIG. 5 is a graph showing a relationship between Vtr-V0 (V) and a density of the K toner reversely transferred to the Y photoconductor; and

FIG. 6 is a schematic diagram illustrating the photoconductor surface potential and transfer bias when the image formation is not performed.

### DETAILED DESCRIPTION

In general, according to one embodiment, as an image forming method used in an image forming apparatus including two or more image forming units used for forming developing agent images with different colors, there is provided an image forming method of setting, forming an electric field with predetermined electrical direction and predetermined strength between the image carrier and the transfer device in the image forming unit which is selected to perform the image formation while at least one of the image forming units is idle for image formation, and forming an electric field between the image carrier and the transfer device of the image forming unit which is idle for the image formation with same electrical direction and lower strength as the electric field formed between the image carrier and the transfer device which perform the image formation.

The image forming unit includes the image carrier, a charger which is provided to oppose the image carrier for charging a surface of the image carrier, an exposure device for forming an electrostatic latent image on the surface of the charged image carrier, a developing device for forming a developing agent image by developing the electrostatic latent image, and a transfer member for transferring the developing agent image onto a transferred material.

In addition, according to one embodiment, there is provided an image forming apparatus which includes two or more image forming units used for forming developing agent images with different colors, and sets, an electric field forming part configured to form an electric field with predetermined electrical direction and predetermined strength between the image carrier and the transfer device in the image forming unit which is selected to perform the image formation while at least one of the image forming units is idle for image formation, and an electric field between the image carrier and the transfer device of the image forming unit which is idle for the image formation with same electrical direction and lower strength as the electric field formed between the image carrier and the transfer device which perform the image formation.

Hereinafter, embodiments will be described in detail with reference to the accompanying drawings.

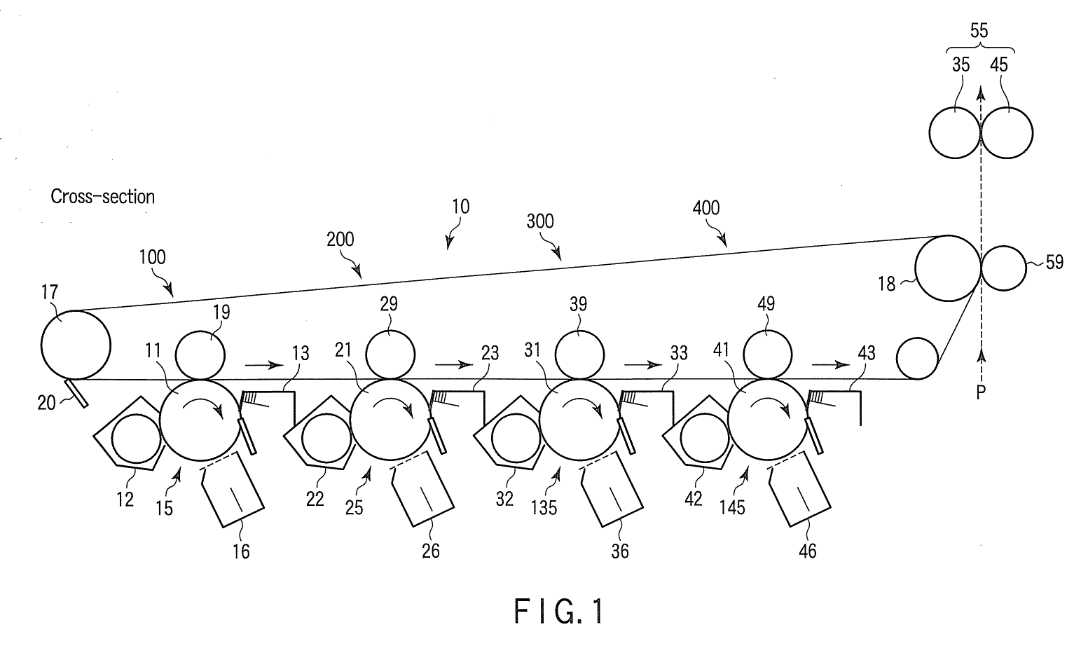

FIG. 1 is a diagram illustrating an example of an image forming apparatus used in an embodiment.

As illustrated, in this image forming apparatus, a photoreceptor drum 11 which is an image carrier is provided to be rotatable in an arrow direction illustrated.

In the vicinity of the photoreceptor drum 11, the following are arranged along a rotation direction. That is, there are provided an exposure unit 15 for forming an electrostatic latent image by exposing a surface of the photoreceptor drum 11 which is charged by a charging roller (not shown), a developing device 12 on a downstream side thereof, which contains a developing agent and develops the electrostatic latent image formed by the exposure unit 15 using the developing agent, and an intermediate transfer belt 10 on the downstream side of the developing device 12 with respect to the photoreceptor drum 21.

In addition, on a downstream side from a position abutting a sheet on the photoreceptor drum 11, a blade cleaning device 13 and a discharge lamp (not shown) are provided.

The intermediate transfer belt has substantially the same width as that of the photoreceptor drum 11. The intermediate transfer belt has a shape of an annular belt, and a tension roller 17 and a backup roller 18 are respectively provided in annular portions on the upstream side and the downstream side of the intermediate transfer belt. The intermediate transfer belt is in contact with the tension roller 17 and the backup roller 18 so as to attach the annular portions to outer peripheries of the tension roller 17 and the backup roller 18.

The tension roller 17 and the backup roller 18 are provided to be rotatable in corresponding arrow directions as illustrated. As the backup roller 18 is rotated, the intermediate transfer belt is annularly sent. The carriage speed is controlled to be in synchronization with a rotation speed of a photoconductor.

The above-mentioned photoreceptor drum 11, the exposure unit 15, the developing device 12, the blade cleaning device 13, and the discharge lamp 16 constitute an image forming unit 100.

On the intermediate transfer belt, between the tension roller 17 and the backup roller 18, along the carrying direction, the first image forming unit 100, a second image forming unit 200, a third image forming unit 300, and a fourth image forming unit 400 are provided. Any of the second image forming unit 200, the third image forming unit 300, and the fourth image forming unit 400 has the same configuration as the first image forming unit 100.

That is, the photoreceptor drum 11, a photoreceptor drum 21, a photoreceptor drum 31, and a photoreceptor drum 41 are provided substantially at the centers of the respective image forming units. In the vicinity of the photoreceptor drum, there is a configuration with an exposure unit 25, an exposure unit 135, and an exposure unit 145; on the downstream side thereof, a developing device 22, a developing device 32, and a developing device 42; a blade cleaning device 23, a blade cleaning device 33, and a blade cleaning device 43 are the same as that of the image forming unit 100.

The configurations of the image forming units are different in terms of the developing agents contained in the developing devices. For example, the developing devices 12, 22, 32, and 42 respectively contain a black developing agent, a yellow developing agent, a magenta developing agent, and a cyan developing agent.

During printing of color images, the intermediate transfer belt 10 is sequentially in contact with the photoreceptor drums 11, 21, 31, and 41. At positions where the intermediate transfer belt 10 abuts the photoreceptor drums 11, 21, 31, and 41, feeding rollers 19, 29, 39, and 49 which are transferring units are provided for the respective photoreceptor drums 11, 21, 31, and 41 with one-to-one correspondence.

That is, the feeding rollers 19, 29, 39, and 49 are provided to come in contact with a rear surface of the intermediate transfer belt 10 at positions abutting the corresponding photoreceptor drums 11, 21, 31, and 41, and are opposed to the photoreceptor drums 11, 21, 31, and 41 with the intermediate transfer belt 10 interposed therebetween. In addition, the feeding rollers 19, 29, 39, and 49 are connected to respective bias sources (not shown). The feeding rollers 19, 29, 39, and 49 are rotated by the movement of the intermediate transfer belt 10.

Here, an image forming process of the image forming apparatus having the above-described configuration will be described. The rotating photoreceptor drums 11, 21, 31, and 41 of the four respective image forming units which are described above are, for example, uniformly charged by chargers 16, 26, 36, and 46 to which AC-superimposed DC biases are applied.

The uniformly charged photoreceptor drums 11, 21, 31, and 41 are illuminated with light by the exposure units 15, 25, 135, and 145 which perform exposure using phosphor, thereby forming electrostatic latent images. The electrostatic latent images are developed by the developing agents of the respective colors of the developing devices 12, 22, 32, and 42, which are sufficiently charged in advance.

Bias voltages are applied from the feeding rollers 19, 29, 39, and 49 to the intermediate transfer belt 10. As the bias voltages are applied, a transfer electric field is formed between the photoreceptor drums 11, 21, 31, and 41 and the intermediate transfer belt 10. Therefore, first, a developing agent image on the photoreceptor drum 11 is transferred onto the intermediate transfer belt 10, and the intermediate transfer belt 10 which holds the developing agent image is carried to reach the photoreceptor drum 21. A developing agent image formed on the photoreceptor drum 21 is overlapped with the developing agent image transferred in advance so as to be transferred. The intermediate transfer belt 10 on which the developing agent image is formed is carried again such that developing agent images of the respective colors are also transferred from the photoreceptor drums 31 and 41.

A secondary transfer roller 59 is disposed at a secondary transfer portion which is a transfer position supported by the backup roller 18 of the intermediate transfer belt 10. In the secondary transfer portion, the backup roller 18 is a conductive roller, and a predetermined secondary transfer bias is applied to the intermediate transfer belt 10.

A sheet P which is an image formation object is sent to the transfer position of the secondary transfer portion from a paper feeding cassette (not shown).

When the sheet P passes between the intermediate transfer belt 10 and the secondary transfer roller 59, the developing agent image on the intermediate transfer belt 10 is secondarily transferred onto the sheet P. After the secondary transfer is finished, the intermediate transfer belt 10 is cleaned by a belt cleaner 20.

The sheet P having the developing agent images secondarily transferred thereon is sent to a fixing device 55 from the intermediate transfer belt 10. The fixing device 55 has a heat roller 35 and a pressurizing roller 45. With regard to the sheet P, as the image passes between the heat roller and the pressurizing roller while being in contact with the heat roller, the image is fixed to the sheet.

In this embodiment using the apparatus illustrated in FIG. 1, when some image forming units perform image formation and at least one of the image forming units does not perform the image formation, in the image forming unit which does not perform the image formation, an electric field between the image carrier and the transfer device has the same direction as that of an electric field between the image carrier and the transfer device of the image forming unit which performs the image formation and has a lower strength.

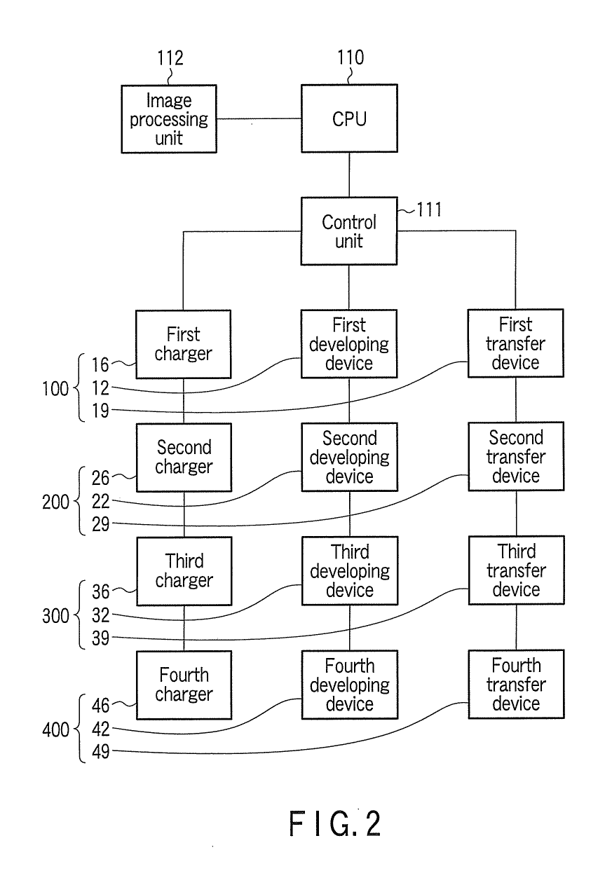

FIG. 2 is a block diagram illustrating the image forming unit of FIG. 1.

As illustrated, the first to fourth image forming units 100, 200, 300, and 400 respectively have the first to fourth chargers 16, 26, 36, and 46, the first to fourth developing devices 12, 22, 32, and 42, and the first to fourth transfer devices 19, 29, 39, and 49, each of which is connected to a control unit 111. The control unit 111 is connected to an image processing unit 112 via a CPU 110.

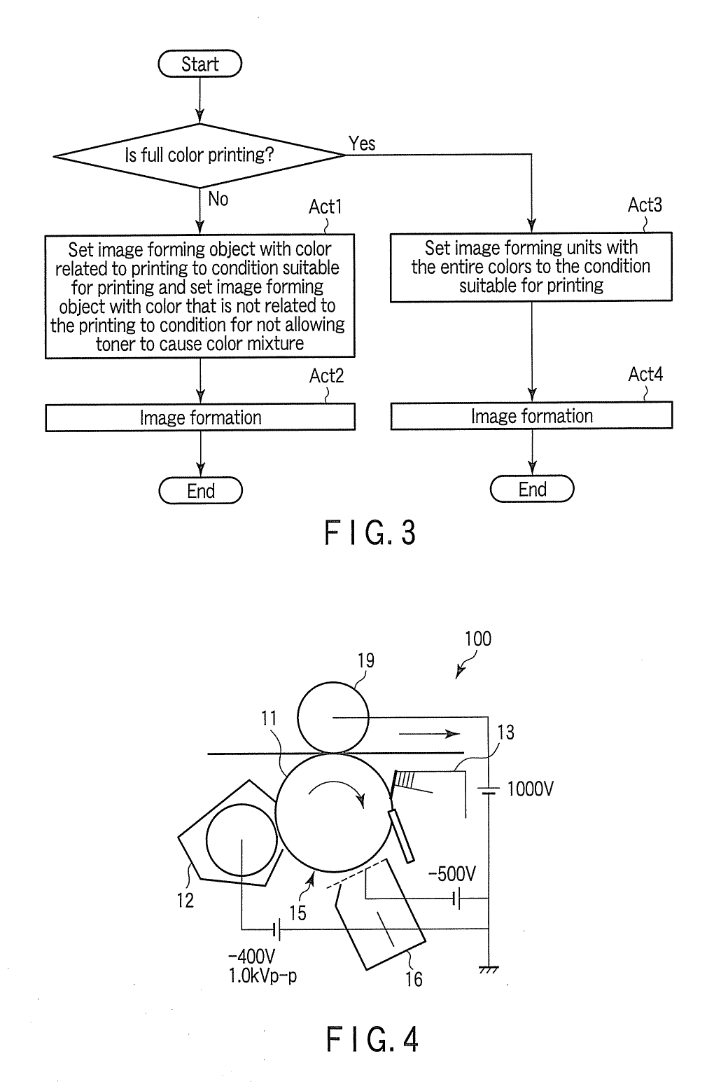

In addition, FIG. 3 is a flowchart illustrating an example of an image forming method according to the embodiment.

According to the embodiment, in such an apparatus, image formation is performed as follows.

If image information sent from the image processing unit 112 is not a full color image, the image forming unit with the color related to printing is set to a condition suitable for printing, and the image forming unit with the color that is not related to printing is set to a condition in which a color mixture does not occur in the toner of the developing device. In at least one image forming unit which does not perform the image formation from among the image forming units 100, 200, 300, and 400, the electric field between the photoconductor and the transfer device is set to have the same direction as that in the case of the image formation and to have a lower level (Act 1), and the image formation is performed (Act 2).

In order to reduce the electric field between the photoconductor and the transfer device, for example, a surface potential of the photoconductor applied by the charger, the bias applied to the developing roller in the developing device, and the bias applied to the transfer roller of the transfer device are set by the control unit 111 to be lower than those related to the image formation.

If the image information sent from the image processing unit 112 is a full color image, the image forming units with the colors of all the image forming units 100, 200, 300, and 400 are set to a condition suitable for printing (Act 3), and the image formation is performed (Act 4).

Here, peripheral speeds of the developing device and the photoconductor may be set to be small.

As a transfer type, any of an intermediate transfer type and a direct transfer type may be used.

A mechanism for returning toner that is not transferred and remains on the photoconductor to the developing device may be provided.

As the mechanism for returning the residual toner to the developing device, there are a mechanism for removing the toner from the photoconductor using a cleaning device such as a cleaning blade and carrying the toner to the developing device, a mechanism for causing the toner to be adhered to the photoconductor so as to be carried to the developing device without a cleaning device, and the like.

If a single color image is formed using the color on the upstream side, during the image formation related to the embodiment, so as not to allow the toner on the upstream side to cause a color mixture in the developing device on the downstream side which is not related to the image formation, in the image forming unit which contains the developing agent of the color that is not related to the image formation, the direction of the electric field between the photoconductor and the transfer roller is not changed from that during the image formation, and the electric field is maintained at a low level. If a negative-polarity toner is used, most of the toner image on the upstream side has a minus polarity, and a part thereof has a plus polarity. If the direction of the electric field is reversed, a large amount of the toner with the minus polarity is reversely transferred to the photoconductor. If the electric field is set to be strong, the toner with the plus polarity is reversely transferred to the photoconductor. Accordingly, the electric field between the image carrier and the transfer device in the image forming unit which does not perform the image formation may be set to be in a range that does not cause a space discharge. In addition, on the image carrier of the image forming unit which does not perform the image formation, the developing agent of the image forming unit which performs the image formation may be charged by the charging device and may be transferred to a transferred member by the transfer device of the image forming unit which does not perform the image formation.

If full color image information is received from the image processing unit, the control unit sets photoconductor surface potentials and transfer biases of the four colors equally to values suitable for the image formation and transfer.

FIG. 4 is a schematic diagram illustrating the photoconductor surface potential and transfer bias during the image formation.

As illustrated in FIG. 4, in the image forming unit 100, a potential of about −500 V is applied to the surface of the photoconductor 11 by the charger 19, and a part exposed with laser according to the image information sent from the image processing unit (not shown) is at −100 V, thereby forming a latent image. A developing bias obtained by superimposing an alternating current of 1.0 kVp-p with a direct current of about −400 V at 10 kHz is applied to the developing roller in the developing device 12, and thus the latent image is visualized. In order to sufficiently apply the developing toner to the photoreceptor drum, the peripheral speed of the developing roller is twice the peripheral speed of the photoconductor. A transfer bias of 1.0 kV is applied to the transfer roller.

The photoconductor surface potentials, the developing biases, and the transfer biases of the image forming units 200, 300, and 400 are substantially the same as those of the image forming unit 100, and ratios of the peripheral speeds of the developing rollers to the peripheral speeds of the photoconductors are the same as that of the image forming unit 100.

As such, the visualized toner images are transferred onto the transfer belt in the order of K, Y, M, and C.

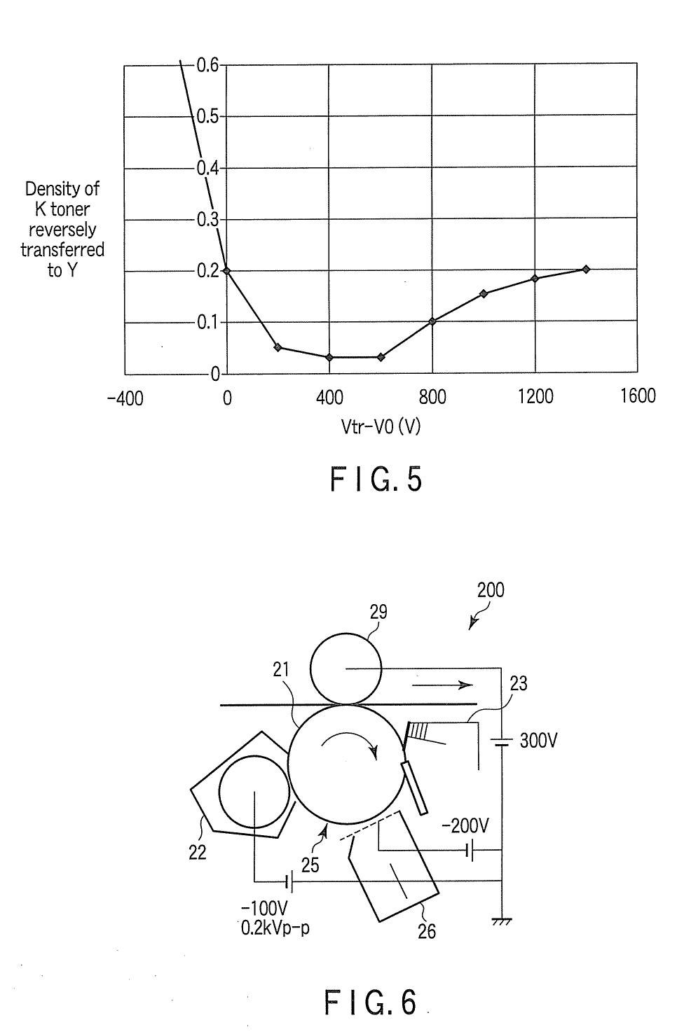

Here, a case where a color mixture occurs when single color image formation is performed is examined. The K toner is transferred onto the intermediate transfer belt, and a part of the toner on the intermediate transfer belt is reversely transferred onto the Y photoconductor on the downstream side. A graph showing a relationship between Vtr-V0 (V) that is generated when the Y transfer bias is changed while the Y photoconductor surface potential is fixed to −500V and a density of the K toner reversely transferred to the Y photoconductor is shown in FIG. 5.

The density of the K toner transferred on the transfer belt, which is peeled off by a Scotch mending tape 810 and is measured by Macbeth RD-19 is 1.45. The density of the K toner adhered to the subsequent Y photoconductor is measured as the reverse transfer from the intermediate transfer belt.

The surface potential V0 of the Y photoconductor is fixed to −500 V, and the transfer bias Vtr is changed. For example, when the transfer bias Vtr is +1000 V, Vtr-V0=1000−(−500)=1500 is satisfied.

As shown in FIG. 5, the reverse transfer to the photoconductor excessively occurs when Vtr-V0 becomes negative.

Accordingly, Vtr-V0=200 to 600 V may be satisfied.

In addition, with regard to Y on the downstream side of K, it is possible that a relationship V0-Vb between the developing direct current bias Vb and the photoconductor surface potential V0 be maintained at −100 V. When V0-Vb is equal to or higher than −200 V, there is a problem in that the Y developing agent carrier is adhered to the photoconductor and thus the developing agent is developed, and when V0-Vb is approximately 0V, there is a problem in that the Y toner is adhered to the photoconductor (fogged).

FIG. 6 is a schematic diagram illustrating the photoconductor surface potential and transfer bias when the image formation is not performed.

For example, during K single color image formation, when Y, M, and C are not related to the image formation, from the above description, the photoconductor surface potential, the developing bias, the transfer bias, and the ratio of the peripheral speed of the developing roller to the peripheral speed of the photoconductor of the image forming unit 100 for forming a K toner image are set to be the same as those of FIG. 4. On the other hand, for example, with regard to setting of the photoconductor surface potential, the developing bias, the transfer bias, and the ratio of the peripheral speed of the developing roller to the peripheral speed of the photoconductor of the image forming unit 200 for forming an Y toner image, as illustrated in FIG. 6, for example, the developing direct current bias Vb may be set to −100 V, the photoconductor surface potential V0 may be set to −200 V, and the transfer bias may be set to +300 V. In addition, if the alternating bias of the Y developing bias is set to a value lower than 1.0 kVp-p, for example, to 0 Vp-p, a problem (fogging) in which the Y toner is adhered to the photoconductor is solved.

With regard to the peripheral speed ratio V1/V0 of the peripheral speed V1 of the developing device to the peripheral speed V0 of the image carrier, the peripheral speed ratio of the image forming unit which does not perform the image formation may be set to be closer to 1 than the peripheral speed ratio of the image carrier and the developing device of the image forming unit which does not perform the image formation.

For example, in relation to the image formation, the peripheral speed of the developing roller may be twice the peripheral speed of the photoconductor. When not in relation to the image formation, it is possible that the peripheral speed of the Y developing roller be set to be approximately the peripheral speed of the photoconductor, for example, to the same peripheral speed of the photoconductor, so that it is difficult for the developing roller to scrape off the K toner adhered to the Y photoconductor.

The photoconductor surface potentials, the developing biases, the transfer biases, and the ratios of the peripheral speed of the developing roller to the peripheral speed of the photoconductor of the image forming unit 300 for forming the M toner image and the image forming unit 400 for forming the C toner image are substantially the same as those of the image forming unit 200.

However, there may be a case where though a small amount of the toner is reversely transferred to the photoconductor, so that a minus-polarity charge is applied to the reversely transferred toner by the charger so as not to be recovered by the developing device. Since the fogged toner of the developing device of the image forming unit which does not perform the image formation is not transferred to the photoconductor, the alternating current bias for developing may be set to OFF or a low value. In addition, in relation to the image formation, the peripheral speed of the developing roller may be set to be twice the peripheral speed of the photoconductor. On the other hand, when not in relation to the image formation, the peripheral speed of the developing roller may be substantially the same peripheral speed as that of the photoconductor.

In addition, the reversely transferred toner is carried to the photoconductor, is returned to the transfer belt by the transfer bias, and is finally recovered by the transfer belt cleaner.

According to the embodiment, by employing such a configuration, it is possible to effectively suppress a color mixture of toner of the developing device which is not related to the image formation with toner of a different color.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming method using an image forming apparatus which includes two or more image forming units each of which includes an image carrier, a charger which is provided to oppose the image carrier configured to charge a surface of the image carrier, an exposure device configured to form an electrostatic latent image on the surface of the charged image carrier, a developing device configured to form a developing agent image by developing the electrostatic latent image, and a transfer member configured to transfer the developing agent image onto a transferred material, and contains developing agents with different colors in the respective developing devices, the method comprising:
forming an electric field with predetermined electrical direction and predetermined strength between the image carrier and the transfer device in the image forming unit which is selected to perform the image formation while at least one of the image forming units is idle for image formation, and
forming an electric field between the image carrier and the transfer device of the image forming unit which is idle for the image formation with same electrical direction and lower strength as the electric field formed between the image carrier and the transfer device which perform the image formation.

2. The method according to claim 1, wherein the developing agent that is not transferred and remains on the image carrier is recovered by the developing device.

3. The method according to claim 1, wherein the electric field between the image carrier and the transfer device of the image forming unit which does not perform the image formation is in a range that does not cause a space discharge.

4. The method according to claim 1, wherein an alternating current bias applied to the developing device of the image forming unit which does not perform the image formation is set to be lower than an alternating current bias applied to the developing device which performs the image formation.

5. The method according to claim 1, wherein, with regard to a peripheral speed ratio V1/V0 of a peripheral speed V1 of the developing device to a peripheral speed V0 of the image carrier, the peripheral speed ratio of the image forming unit which does not perform the image formation is closer to 1 than the peripheral speed ratio of the developing device to the image carrier of the image forming unit which performs the image formation.

6. The method according to claim 1, wherein, on the image carrier of the image forming unit which does not perform the image formation, the developing agent of the image forming unit which performs the image formation is charged by the charging device, and is transferred onto the transferred member by the transfer device of the image forming unit which does not perform the image formation.

7. An image forming apparatus which includes two or more image forming units each of which includes an image carrier, a charger which is provided to oppose the image carrier for charging a surface of the image carrier, an exposure device configured to form an electrostatic latent image on the surface of the charged image carrier, a developing device configured to form a developing agent image by developing the electrostatic latent image, and a transfer member configured to transfer the developing agent image onto a transferred material, and contains developing agents with different colors in the respective developing devices, an electric field forming part configured to form an electric field with predetermined electrical direction and predetermined strength between the image carrier and the transfer device in the image forming unit which is selected to perform the image formation while at least one of the image forming units is idle for image formation,
and an electric field between the image carrier and the transfer device of the image forming unit which is idle for the image formation with same electrical direction and lower strength as the electric field formed between the image carrier and the transfer device which perform the image formation.

8. The apparatus according to claim 7, further comprising a mechanism configured to recover the developing agent that is not transferred and remains on the image carrier using the developing device.

9. The apparatus according to claim 7, wherein the electric field between the image carrier and the transfer device of the image forming unit which does not perform the image formation is in a range that does not cause a space discharge.

10. The apparatus according to claim 7, wherein an alternating current bias applied to the developing device of the image forming unit which does not perform the image formation is set to be lower than an alternating current bias applied to the developing device which performs the image formation.

11. The apparatus according to claim 7, wherein, with regard to a peripheral speed ratio V1/V0 of a peripheral speed V1 of the developing device to a peripheral speed V0 of the image carrier, the peripheral speed ratio of the image forming unit which does not perform the image formation is closer to 1 than the peripheral speed ratio of the developing device to the image carrier of the image forming unit which performs the image formation.

12. The apparatus according to claim 7, wherein, on the image carrier of the image forming unit which does not perform the image formation, the developing agent of the image forming unit which performs the image formation is charged by the charging device, and is transferred onto the transferred member by the transfer device of the image forming unit which does not perform the image formation.
